(19) United States
(12) Patent Application Publication
(10) Pub. No.: US 2007/0194879 A1
(43) Pub. Date: Aug. 23, 2007

(54) Method and device for detecting an invalid RFID tag and method for manufacturing an RFID tag

(75) Inventors: Michael Backes, Rentrisol (CH); Christian Cachin, Thalwil (CH); Sastry S. Duri, Yorktown Heights, NY (US); Guenter Karjoth, Waedenswil (CH); Luke James O'Connor, Adliswil (CH)

Correspondence Address: Anne Vachon Dougherty, 3173 Cedar Road, Yorktown Hts, NY, 10598, US

(73) Assignee: International Business Machines Corporation, Armonk, NY (US)

(21) Appl. No.: 11/415,796

(22) Filed: May 2, 2006

(30) Foreign Application Priority Data
May 2, 2005 (EP) 05009590.0

(51) Int. Cl. G05B 19/00

(52) U.S. Cl. 340/5.8; 340/572.1; 340/10.1; 713/168; 340/5.61

(57) ABSTRACT

For detecting an invalid RFID tag, an identifier and authentication information is read from a given RFID tag. The authentication information is then verified dependent on at least a given part (IDP_TAG) of the identifier (ID_TAG) and it is determined that the given RFID tag is the invalid RFID tag if the verification was negative. Accordingly, an RFID tag is manufactured by determining an identifier (ID), determining an authentication information dependent on at least a given part (IDP) of the identifier (ID) and storing the identifier (ID) and the authentication information on or in the RFID tag.

### FIELD OF THE INVENTION

The present invention relates to a method and device for detecting an invalid Radio Frequency Identification (RFID) tag and a method for producing a corresponding valid RFID tag which may be detected by the foregoing method.

### BACKGROUND OF THE INVENTION

RFID tags are available in different materials and shapes. They typically comprise a microchip with an antenna for locating and communicating with a reader. RFID tags comprise a storage device, in which a full identifier is stored. Upon request by, for example, a radio signal, the RFID tag responds by transmitting its full identifier. It may, however, also just transmit part of its full identifier. There have been approaches of standardizing the full identifiers of RFID tags. Such an approach is the so-called EPC global standard. EPC stands for Electronic Product Code, which is an identification scheme designed to enable a unique identification of all physical objects. The EPC code ranges from 64 bits to 256 bits with four distinct fields. In case of a 96 bit code, the EPC code comprises a header covering the bits 0 to 7 and defining the length of the code. The second field is the so-called EPC manager covering, for example bits 8 to 35, and typically containing information about the manufacturer of the product to which the RFID tag is attached. The third field is the so-called object class, covering, for example bits 36 to 59, and referring to the exact type of product in the same way as a stock keeping unit. The fourth field is referred to as serial number and may cover bits 60 to 96. This fourth field provides a unique identifier for individual products depending on the length of the EPC code. It may be possible to individually mark every product with a unique full identifier.

RFID tags may in this way be used for automatically supervising the flow of products through a supply chain up to the customer, even after purchase of the product.

RFID tags are getting smaller and smaller and also cheaper, so in the near future they may replace so-called bar code systems. They will enable tracking of the individual products along their way from being produced to being sold with respective RFID tag readers installed in given locations. Also in retail stores, they may speed up the registration of goods one intends to buy and render it unnecessary to take the goods out of a shopping cart.

However, there are also security and privacy concerns related to RFID. The article “RFID's Security Challenge, Security—and its high cost—appears to be the next hurdle in the widespread adoption of RFID.” by Thomas Claburn, George V. Hulme, Nov. 15, 2004 discloses the basic RFID tag concept and also addresses the problem of information security. In this article so-called blocker tags are disclosed, which are characterized in that they disturb the transmission between a selected group of RFID tags or all RFID tags in a certain area. Such a blocker tag could be embedded in a bag or a pocket, for example, to prevent their content to be revealed. Wearing a blocker tag would protect the person from having his belongings scanned by unauthorized people. A blocker tag works by responding to readers' queries, by simultaneously replying with a yes and a no, which may be represented by a binary 1 or a binary 0.

US 2004/0223481 A1 discloses a blocker device, which is operative to receive a communication directed from the reader to one or more of the RFID devices, and to generate, possibly based on information in the received communication, an output transmittable to the reader. The output simulates one or more responses from at least one of the RFID devices in a manner which prevents the reader from determining at least a portion of the identifier of at least one of the RFID devices. The blocker device may itself comprise one of the RFID devices.

Hash-functions and padding are disclosed in the Handbook of Applied Cryptography, by A. Menezeus, P. van Oorschot et al., CRC Press, 1996, Chapter 9, which is also freely available in the Internet at the web address cacr.math.uwaterloo.ca/hac.

It is a challenge to provide a more reliable method for detecting an invalid RFID tag. It is furthermore a challenge to provide a device for more reliably detecting an invalid RFID tag. Furthermore, it is a challenge to provide a method for manufacturing an RFID tag which is suitable for being detected as an invalid RFID tag.

### SUMMARY OF THE INVENTION

According to one aspect of the invention, a method for detecting an invalid RFID tag is provided that comprises reading an identifier and authentication information from a given RFID tag, verifying that authentication information dependent on at least a given part of the identifier and determining that the given RFID tag is an invalid RFID tag if the verification was negative. This has the advantage that an immediate validation of the RFID tag is possible. Thus, it is not necessary to establish an on-line connection with a back-end database to check the identifier of the given RFID tag nor is a large memory necessary for storing valid identifiers. In addition, no cryptographic operations need to be performed on or in the RFID tag, so that the method can be applied to very simple structured RFID tags, for example, RFID tags of EPC global class zero. Invalid RFID tags may be unauthorized RFID tags or faked RFID tags, for example. Thus, the method according to the first aspect of the invention enables efficient counterfeit detection.

In a preferred embodiment of the first aspect of the invention, the method comprises conducting the verification of the authentication information dependent on a first secret key. This ensures a high degree of correct detection of invalid RFID tags and makes it possible, dependent on the length of the first secret key, to protect with a high probability against faking of authorized RFID tags.

In a further preferred embodiment of the first aspect of the invention, the method comprises conducting the verification by hashing the first secret key and at least a given part of the identifier and comparing at least part of a hash-output of the hashing with the authentication information.

In this context, hashing means generating an authentication value by using a message authentication code (MAC). The authentication value (or authenticator or hash-output) is a short piece of information used to authenticate a message (a bit string). A MAC algorithm (sometimes termed a keyed hash function) accepts as input a secret key as well as the message, and produces a MAC. MAC algorithms can be constructed from other cryptographic primitives, such as cryptographic hash functions (as in the case of HMAC [RFC 2104]) or from block cipher algorithms (OMAC and PMAC). Any iterative cryptographic hash function, such as SHA-1, may be used in the calculation of an HMAC. The cryptographic strength of the HMAC depends upon the cryptographic strength of the underlying hash function and on the size and quality of the key. Using a MAC provides a high degree of protection against invalid RFID tags. The degree of protection achieved depends on the cryptographic strength of the HMAC and on the length of the authentication information.

In a further preferred embodiment of the first aspect of the invention, the method comprises conducting the verification by hashing the first secret key, at least a given part of the identifier and additional context information and comparing at least part of the hash-output of the hashing with the authentication information. This has the advantage that the degree of protection may be increased by adding the additional context information. This additional context information may preferably be a country code, an area code, a region code, a zip code, or an address of an internet service provider. With the additional information, a determination can be made as to whether the given RFID tag is, for example, valid for the respective country or respective area.

In a further preferred embodiment of the first aspect of the invention, the additional context information comprises an expiration time. This may also further extend the scope of protection and enables to check whether, for example, a product marked with the RFID tag is still usable.

In a further preferred embodiment of the first aspect of the invention, the additional context information comprises a production serial number or a part of it. This may also further extend the scope of protection and enables the method to check whether, for example, the identifier or the full identifier or the part of the hash output was copied to another RFID tag in an unauthorized way.

In a further preferred embodiment of the first aspect of the invention, the method comprises reading a given encrypted information unit from the given RFID tag, decrypting the encrypted information unit dependent on a second secret key to the authentication information and/or the at least part of the identifier. In this way, the degree of protection may be even more enhanced. In this respect the encrypted information unit represents the authentication information.

In a further preferred embodiment of the first aspect of the invention, the method comprises reading the authentication information or the encrypted information unit from a full-identifier data storage space of a given RFID tag. Accordingly, the method can be implemented for non-modifiable RFID tags, because there is no need to modify them and therefore the method and tages can be compliant with, for example, an EPC class zero RFID tag.

In a further preferred embodiment of the first aspect of the invention, the method comprises reading the authentication information or the encrypted information unit from an additional data storage space of the given RFID tag. This enables on one hand to use more or all of the full-identifier data storage space for the identifier and to extend the bit length of the authentication information to the bit storage capacity provided by the additional data storage space. In this way, the degree of protection may even be further enhanced.

In a further preferred embodiment of the first aspect of the invention, the method comprises reading the authentication information or the encrypted information unit from a magnetically, optically, or mechanically readable medium associated with the RFID-tag, (e.g. a bar-code or a magnetic strip). Thus, the demand for information stored on the RFID tag can be made without needing to modify the internal electronics. In this way, for example, an EPC class zero RFID tag may be provided with additional information.

According to a second aspect of the invention, a device for detecting an invalid RFID tag is provided, which corresponds to the method for detecting the invalid RFID tag and its preferred embodiments. Also the advantages of the device for detecting the invalid RFID tag and its preferred embodiments correspond to the respective advantages of the method and its preferred embodiments.

According to a third aspect of the invention, a method for generating a verifiable RFID tag is provided comprising determining an identifier, determining an authentication information dependent on at least a given part of the identifier and storing the identifier and the authentication information on or in the RFID tag. The identifier may be determined in every way which is possible, for example, by applying the EPC standardization protocol. The method for manufacturing the RFID tag provides the RFID tag, from which the identifier and the authentication information may be read in the context of the method for detecting the invalid RFID tag. In this way, the method for manufacturing the RFID tag and its preferred embodiments corresponds to the method for detecting the invalid RFID tag and its preferred embodiments and the same is true for the respective advantages.

### BRIEF DESCRIPTION OF THE DRAWINGS

The invention and its embodiments will be more fully appreciated by reference to the following detailed description of presently preferred but nonetheless illustrative embodiments in accordance with the present invention when taken in conjunction with the accompanying drawings.

The figures are illustrating:

FIG. 1 illustrates an RFID tag system with a reader unit,

FIG. 2 provides a flow-chart for manufacturing an RFID tag, and

FIG. 3 provides a flow-chart for determining an invalid RFID tag.

### DETAILED DESCRIPTION OF THE DRAWINGS

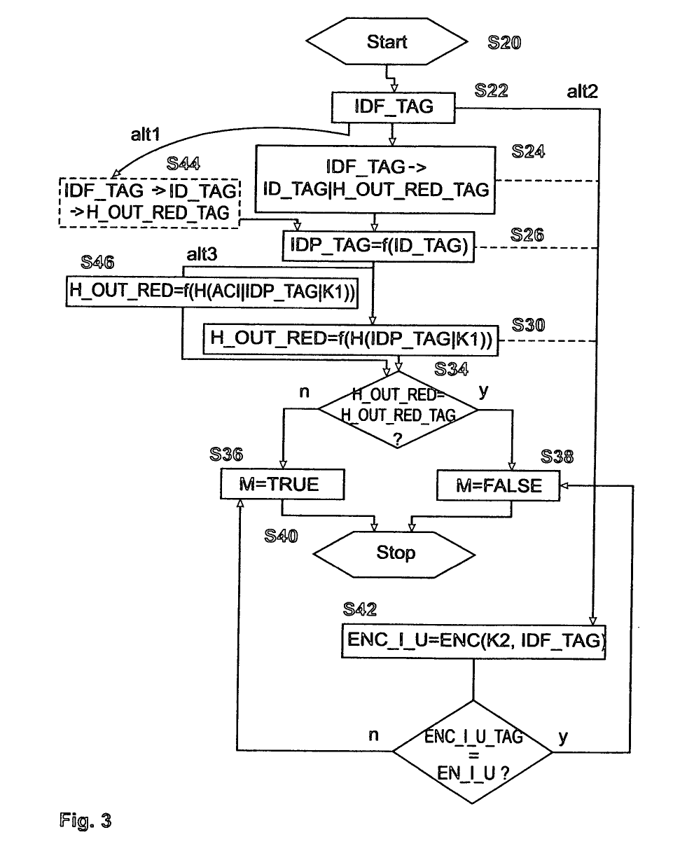

FIG. 1 shows an RFID tag system. It comprises several regular RFID tags 1-3, of which three are by way of example shown here. The tags may, however, also be present in a larger number of, for example, 200 regular RFID tags. In addition to tags 1-3, an invalid RFID tag 4 is illustrated.

The regular RFID tags 1-3 are RFID tags which are valid for the given business process. They may have full identifiers, which comply, for example, to the EPC (Electronic Product Code) standard. The electronic product code ranges from 64 bits to 256 bits with four distant fields. The manufacturer of goods, to which the regular RFID tags 1-3 may be attached, may have allocated certain parts of the full identifier individually to each of the regular RFID tags 1-3. The invalid RFID tag 4 may for example be a universal blocker RFID tag or it may also just be a selective blocker RFID tag or it may be an RFID tag with an unauthorized identifier. It may contain a given memory space for storing data. In particular the blocker RFID tag may be a malicious RFID tag. The invalid RFID tag 4 is not intended to be present by the manufacturer of the products labeled with regular RFID tags 4. The invalid RFID tag 4 may be a blocker RFID tag, e.g., selectively blocking just one full identifier value or several full identifier values.

Each respective RFID tag may be embedded in a given body, such as a paper label, a plastic foil, etc.

In addition to that, a reader unit 6 is provided, which comprises an antenna 8 for transmitting signals to and receiving signals from the regular RFID tags 1-3 and the invalid RFID tag 4. It further comprises a data and program storage device 10 and a data processor 11 designed for running programs, which are described below with reference to the flow chart of FIG. 3.

The regular RFID tags 1 to 3 each comprise a full-identifier data storage space 12 which is used for storing a full-identifier IDF. The full-identifier data storage space 12 is, by way of example, a read-only memory. It may, however, also be any other type of memory. RFID tags 1 and 3 may be RFID tags according to EPC global class zero. RFID tag 2 comprises an additional data storage space 14 with, for example, 8 bytes of additional memory. The additional data storage space 14 may, for example, be a write-once-read-many memory. RFID tag 3 comprises a magnetically, optically or mechanically readable medium 16 associated with the RFID-tag, such as a bar code or a magnetic strip. The RFID tags may also comprise a production serial number, being stored in a respective memory location, which can only be set by the chip manufacturer and can not be overwritten by any other party.

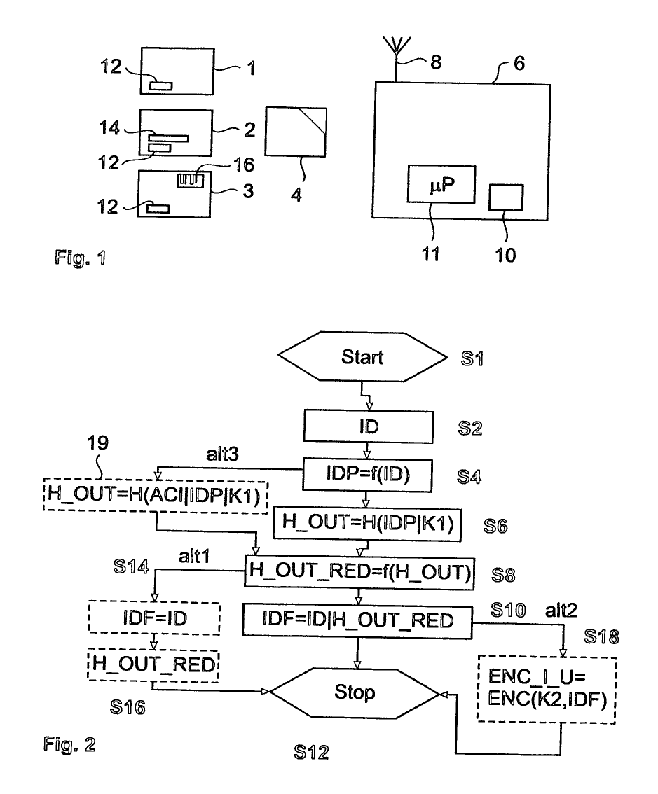

During the personalization of each respective RFID tag 1 to 3, which may take place during the manufacturing process or at the location which is using the respective RFID tag, (e.g., at the retailer's location), an RFID generating program is started in a step S1 (FIG. 2). The program is preferably run on a production device comprising respective computational and storage means.

In a step S2, an identifier ID is determined. The identifier ID is preferably determined in compliance with the electronic product code (EPC). It may, however, also be determined in another way. It may be part of the full identifier IDF or also may have a bit length of up to the bit length of the full identifier IDF. The full identifier IDF may be in compliance with the electronic product code standard. In case of a 96 bit length of the full identifier, it then has four distinct fields. The first field is the header field comprising bits 0 to 7 and defining the length of the code. The second field is the EPC manager with the bits 8 to 35, which typically contains the manufacturer of the product the RFID tag is attached to. The third field is the object class containing bits 36 to 59 and referring to the exact type of product in the same way as a stock-keeping unit. The fourth field is a serial number and comprises bits 60 to 96.

In step S4, at least a part IDP of the identifier ID is extracted. The extracted IDP may be the whole identifier ID or only a part of it. By way of example, the part IDP of the identifier ID may be the first 16 bits of the serial number field or a larger or lower bit number of bits from the serial number field. It may, for example, also comprise one or more of the first to third fields of the electronic product code.

In a step S6, the part IDP of the identifier ID is bitwise concatenated to a first secret key K1 and is used as an input for a hash-function H. The hash-function may by way of example be of the type SHA-1 or SHA-256. Depending on the hash-function used, the concatenated bit string of the part IDP of the identifier and the first key K1 may be padded with additional bits in order to provide the appropriate input length for the respective hash-function.

The hash-function H is calculated in the step S6 and an output H_OUT of the hash-function H is allocated a hash-value calculated by the hash-function H.

Then, in step S8, a part H_OUT_RED of the output H_OUT is extracted. The extraction function for this step need not be identical to the extraction function used in step S4. For example, the least significant 16 bits of the output H_OUT of a hash-function H may be assigned to the part H_OUT_RED of the output H_OUT of the hash-function H. However, any other part of the output H_OUT of the hash-function may alternatively be allocated to the part H_OUT_RED.

Then, in a step S10, the full identifier IDF is assigned the identifier ID concatenated with the part H_OUT_RED of the output H_OUT of the hash-function H. In this way, the information is further compressed making it possible to squeeze all the information needed in a way that it fits in the respective full-identifier data storage space 12 of the respective RFID tag 1 to 3. The part H_OUT_RED of the output H_OUT of the hash-function H represents authentication information for the respective RFID tag 1 to 3.

The full identifier IDF is then written on the respective RFID tag 1 to 3 in its full-identifier data storage space 12. After that, the program is terminated in a step S12.

In an alternative embodiment, designated in FIG. 2 as alt 1, as an alternative to step S10, steps S14 and S16 are provided, for use when the RFID tag 2 has been generated with the additional data storage space 14. In the step S14, the full identifier IDF is assigned the identifier ID. In this case, therefore, the identifier ID may have the full length of the full identifier IDF. So in the case of the electronic product code of a bit length of 96, the identifier and the full identifier may have the bit length of up to 96 bits. The full identifier IDF is then stored in the full-identifier data storage space 12 of the RFID tag 2. In the step S16, the part H_OUT_RED of the output H_OUT of the hash-function H is stored in the additional data storage space 14. The part H_OUT_RED of the output H_OUT of the hash-function H may in this case have a bit length of up to the possible bit length that can be stored in the additional data storage space 14. This may, by way of example, be 8 bytes. In step S16 the part H_OUT_RED of the output H_OUT of the hash-function H may be written magnetically or in an optically or mechanically readable manner to the magnetically, optically or mechanically readable medium 16 associated with the RFID-tag, 3.

In a further alternative embodiment, designated in FIG. 2 as alt 2, in the step S10, only the full identifier IDF is determined. Then, in a step S18, an encrypted information unit ENC_I_U is determined by an encryption ENC of the full identifier IDF by using a second secret key K2. This encrypted information unit ENC_I_U is then written into the additional data storage space 14. After that, the program is terminated in step S12. The step S18 can alternatively be performed after any of the steps S2, S4, S6, S8 so that the respective step result is encrypted in step S18.

Optionally, designated in FIG. 2 as alt 3, a step S19 may be provided replacing step S6 and differing from step S6 in that, for the input of the hash-function H, an additional context information ACI is concatenated to the part IDP of the identifier ID and the first secret key K1. This additional context information ACI may comprise, for example, one or more of a country code, an area code, and an expiration time. The additional context information ACI may, however, also comprise the production serial number or a part of it. This enhances security, such that, even if the identifier or the full identifier is copied in an unauthorized way into the full-identifier data storage space 12 of another RFID tag, it may be detected by the non-matching production serial number.

In the program and data storage device 10 of the reader unit 6, a program for identifying an invalid RFID tag is stored. The program is started in a step S20 (FIG. 3). In a step S22, a full identifier IDF_TAG of a given tag being present nearby the reader unit, which may be one of the RFID tags 1 to 4, is read. This may be accomplished by requesting the respective RFID tag to send its full identifier IDF, applying for example the tree walking singulation protocol or the ALOHA protocol. If more than one RFID tag is present, the program may be run in order to check each RFID tag whether it is the invalid RFID tag, respectively.

In step S24, the full identifier IDF_TAG of given tag 1 to 4 is separated into the identifier ID_TAG of the given tag 1 to 4 and the part H_OUT_RED_TAG of the output of the hash-function H of the given tag H. This may be accomplished if the respective bits being reserved for the identifier ID_TAG of the given tag and the part H_OUT_RED_TAG within the full identifier IDF_TAG of the given tag 1 to 4 are known for the program. It corresponds to the way the respective RFID tag was manufactured using the program according to FIG. 2.

In a step S26, the part IDP_TAG of the identifier ID_TAG of the given RFID tag 1 to 4 is extracted from the identifier ID_TAG of the given RFID tag 1 to 4. For that purpose, a given bit sequence of the identifier ID_TAG of the given RFID tag is extracted, which corresponds to respective bit sequence used for the part IDP of the identifier in the step S4 of the program according to FIG. 2.

Then, in a step S30, a part H_OUT_RED of the output H_OUT of the hash-function H is determined by calculating the respective hash-function H using as input the part IDP_TAG of the identifier of the given RFID tag 1 to 4 concatenated with the first secret key K1.

In a following step S34, the part H_OUT_RED of the output of the hash-function H is compared to the part H_OUT_RED_TAG of the given tag 1 to 4. If the two are not equal to each other, then a marker M is assigned a true value TRUE in a step S36. Otherwise, the marker is assigned a false value FALSE in a step S38. A true value of the marker M then signals that the given RFID tag 1 to 4 is an invalid tag and therefore, with a probability of over 50%, is the invalid RFID tag 4. The false value of the marker M signals that the given RFID tag 1 to 4 is a valid tag and therefore one of the regular RFID tags 1 to 3. After the steps S36 and S38, the program is terminated in a step S40.

Depending on the type of RFID tag to be verified in the step S24, for example, in the case of the RFID tags 2 or 3, only the identifier ID_TAG of the given RFID tag 2 or 3 is extracted from the full identifier IDF_TAG of the given RFID tag 2 or 3. In addition to that, a step S44 can be provided as an alternative, designated as alt 1, to step S24, in which the part H_OUT_RED_TAG of the given tag 2, 3 is read. This may, in the case of the RFID tag 2, be accomplished by requesting that the contents of the additional data storage space 14 be sent to the reader unit 6. In case of the RFID tag 3, this may be accomplished by reading the information from the magnetically, optically or mechanically readable medium 16 associated with the RFID tag 3.

As another alternative, designated as alt 2, a step S42 may be provided in which the content of the additional data storage space 14 is read as the encrypted information unit ENC_I_U_TAG of the given RFID tag 1 to 4, and an encrypted information unit ENC_I_U is determined by an encryption ENC of the full identifier IDF by using a second secret key K2. This encrypted information unit ENC_I_U is then compared with the encryption information unit ENC_I_U_TAG of the given RFID tag 1 to 4. The result signals whether the given RFID tag 1 to 4 is an invalid tag or not. This is like step S34 except that the encrypted values are compared. The step S42 can alternatively be entered after completion of any of the steps S24, S26, S30. The encryption then is performed using the key K2 and the respective result of the respective step.

In addition to that or alternative to that, designated as alt 3, a step S46 may be provided, if during the manufacturing of the RFID tags 1 to 3 additional context information ACI was added before hashing. In this case, the part H_OUT_RED of the output of the hash-function H is calculated in step S44 instead of the step S30 additionally using the respective additional context information ACI as input for the hash-function H. The additional context information ACI may then be validated by comparing it to a given set of values and, depending on the results of the comparison, the invalid RFID tag may be detected. Validation is preferably done by iterating through all possible values of the additional context information ACI. If no chosen value matches, then the identifier represents an invalid tag ID. In particular it is advantageous if the additional context information ACI comprises the production serial number or a part of it. This enhances security since, even if the identifier or the full identifier or the part H_OUT_RED of the output of the hash-function H is copied in an unauthorized way into the full-identifier data storage space 12 of another RFID tag, then this may be detected by the non-matching production serial number.

Preferably, the key length of the first key K1 should be in the range of the bit length of the authentication information which results in a preferred trade-off between security and efficiency in calculation. In the instance when the hash-function H is applied, the key length of the first key K1 should at least have the same bit size as the part H_OUT_RED of the output H_OUT of the hash-function H.

The invention has been described with reference to preferred embodiments. It will be understood by those skilled in the art that changes may be made to processing steps, bit lengths, application of hashing functions, etc. without departing from the spirit and scope of the invention as set forth in the appended claims.

1. A method for detecting an invalid Radio Frequency Identification (RFID) tag comprising the steps of:
reading at least part of an identifier and authentication information from a given RFID tag;
verifying said authentication information dependent on at least a given part of said identifier; and
determining that said given RFID tag is an invalid RFID tag based on said verifying.

2. The method according to claim 1, wherein said verifying of said authentication information comprises verifying using a first secret key.

3. The method according to claim 2, wherein said verifying using a first secret key comprises the steps of:
hashing said first secret key and said at least a given part of said identifier; and
comparing at least part of a hash-output of said hashing with said authentication information.

4. The method according to claim 2 wherein said verifying using a first secret key comprises the steps of:
hashing said first secret key, said at least a given part of said identifier, and additional context information; and
comparing at least part of said hash-output of said hashing with said authentication information.

5. The method according to claim 4, wherein said additional context information comprises one or more of a country code, an area code, an expiration time, a production serial number, and parts of any of the foregoing.

6. The method according to claim 1 wherein said RFID tag comprises a first encrypted information unit, said method further comprising the steps of;
reading a first encrypted information unit from said given RFID tag;
encrypting a second encrypted information unit by applying a second secret key to said identifier; and
comparing said first encrypted information unit to said second encrypted information unit.

7. The method according to claim 6 wherein said reading comprises at least one of reading from a full identifier storage space of said RFID tag, reading from an additional data storage space of said RFID tag, and reading from a magnetically, optically or mechanically readable medium associated with said RFID tag.

8. A device for detecting an invalid RFID tag, comprising:
a reader for reading at least an identifier and authentication information from a given RFID tag; and
a verifier for verifying said authentication information dependent on at least a given part of said identifier and for determining that said given RFID tag is an invalid RFID tag based on said verifying.

9. The device according to claim 8, wherein said verifier further comprises means for applying a first secret key for said verifying.

10. The device according to claim 9, wherein said verifier conducts verification by hashing said first secret key and at least a given part of said identifier and comparing at least part of a hash-output of said hashing with said authentication information.

11. The device according to claim 9, wherein said verifier conducts verification by hashing said first secret key, at least a given part of said identifier, and additional context information and comparing at least part of said hash-output of said hashing with said authentication information.

12. The device according to claim 8 wherein each RFID tag further comprises first encryption information and wherein said verifier further comprises encryption means for encrypting second encryption information by applying a second key to at least one of said authentication information and said at least part of said identifier for comparison of said second encryption information to said first encryption information for verification of said RFID tag.

13. The device according to claim 8, wherein said reader is adapted to read information from one or more of a full-identifier data storage space of said given RFID tag, an additional data storage space of said given RFID tag, and from a magnetically, optically or mechanically readable medium associated with the RFID tag.

14. A method for providing a verifiable RFID tag, comprising the steps of:
determining an identifier;
determining an authentication information dependent on at least a given part of said identifier; and
storing said identifier and said authentication information on or in said RFID tag.

15. The method according to claim 14, wherein said determining said authentication information comprises using a first secret key.

16. The method according to claim 15, wherein said determining said authentication information comprises the steps of;
hashing said first secret key and said at least given part of said identifier; and
allocating at least part of a hash-output of said hashing to said authentication information.

17. The method according to claim 15 wherein said determining said authentication information comprises the steps of:
hashing said first secret key, said at least given part of said identifier, and additional context information; and
allocating at least part of a hash-output of said hashing to said authentication information.

18. The method according to claim 14 further comprising determining an encrypted information unit by encrypting at least one of said authentication information and said at least part of said identifier dependent on a second secret key and storing said encrypted information unit on or in said RFID tag.

19. The method according to claim 14 further comprising storing said authentication information in at least one of a full-identifier data storage space of said RFID tag, an additional data storage space of said RFID tag, and a magnetically, optically or mechanically readable medium associated with the RFID-tag.

20. The method according to claim 18 further comprising storing at least one of said authentication information and said encrypted information in at least one of a full-identifier data storage space of said RFID tag, an additional data storage space of said RFID tag, and a magnetically, optically or mechanically readable medium associated with the RFID-tag.
